(19) United States
(12) Patent Application Publication
(10) Pub. No.: US 2021/0183092 A1
(43) Pub. Date: Jun. 17, 2021

(54) MEASURING APPARATUS, MEASURING METHOD AND MICROSCOPE SYSTEM

(71) Applicant: OLYMPUS CORPORATION, Tokyo (JP)

(72) Inventor: Shunichi KOGA, Tokyo (JP)

(73) Assignee: OLYMPUS CORPORATION, Tokyo (JP)

(21) Appl. No.: 17/174,484

(22) Filed: Feb. 12, 2021

Related U.S. Application Data
(63) Continuation of application No. PCT/JP2018/037497, filed on Oct. 9, 2018.

(51) Int. Cl. G06T 7/593; H04N 5/232; G06T 7/579; G01B 21/22; G01B 11/06; G02B 21/26; G02B 21/36

(52) U.S. Cl. CPC G06T 7/593; H04N 5/23299; G06T 7/579; G01B 21/22; G06T 2207/10012; G02B 21/26; G02B 21/362; G06T 2207/10056; G01B 11/0608

(57) ABSTRACT

A measuring apparatus includes: an imager that includes an optical system that is telecentric at least on an object side, and that acquires an image of an imaging object; a rotor that relatively and rotationally moves the imager and the imaging object about an axis orthogonal to an optical axis of the optical system; an encoder that detects a rotation angle formed by means of the rotor; and a processor including hardware, the processor being configured to calculates, by a principle of triangulation, a height dimension of the imaging object on the basis of a result of matching processing of two images acquired by the imager before and after a rotational movement by means of the rotor and the rotation angle detected by the encoder.

### CROSS-REFERENCE TO RELATED APPLICATIONS

This is a continuation of International Application PCT/JP2018/037497 which is hereby incorporated by reference herein in its entirety.

### TECHNICAL FIELD

The present invention relates to a measuring apparatus, a measuring method and a microscope system.

### BACKGROUND ART

There is a known microscope system in which the distance between an object and an imaging unit in an optical axis direction is changed, and the height dimension at a focused position on an image acquired by the imaging unit is measured (for example, see Patent Literature 1).

### CITATION LIST

### Patent Literature

### {PTL 1} Publication of Japanese Patent No. 5730696

### SUMMARY OF INVENTION

An aspect of the present invention is a measuring apparatus including: an imager that includes an optical system that is telecentric at least on an object side, and that acquires an image of an imaging object; a rotor that relatively and rotationally moves the imager and the imaging object about an axis orthogonal to an optical axis of the optical system; an encoder that detects a rotation angle formed by means of the rotor; and a processor including hardware, the processor being configured to calculates, by a principle of triangulation, a height dimension of the imaging object on the basis of a result of matching processing of two images acquired by the imager before and after a rotational movement by means of the rotor and the rotation angle detected by the encoder.

In addition, another aspect of the present invention is a measuring method including: arranging an imaging unit that includes an optical system that is telecentric at least on an object side and that acquires an image of an imaging object and the imaging object so as to form a first rotation angle about an axis orthogonal to an optical axis of the optical system to acquire a first image with the imaging unit; arranging the imaging unit and the imaging object so as to form a second rotation angle about the axis to acquire a second image with the imaging unit; and calculating, by a principle of triangulation, a height dimension of the imaging object on the basis of a result of matching processing of the first image and the second image acquired by the imaging unit and a difference between the first rotation angle and the second rotation angle.

In addition, another aspect of the present invention is a microscope system including: a microscope that includes: a stage on which an imaging object is mounted; an imager that includes an objective optical system that is telecentric at least on an object side and that acquires an image of the imaging object; a rotor that relatively and rotationally moves the imager and the stage about an axis orthogonal to an optical axis of the objective optical system; and an encoder that detects a rotation angle between the imager and the stage, which is formed by means of the rotor; and a processor including hardware, the processor being configured to calculate, by a principle of triangulation, a height dimension of the imaging object on the basis of a result of matching processing of two images acquired by the imager before and after a rotational movement by means of the rotor and the rotation angle detected by the encoder.

### BRIEF DESCRIPTION OF DRAWINGS

FIG. 1 is an overall configuration diagram showing a microscope system according to an embodiment of the present invention.

FIG. 2 is a schematic diagram showing a state in which an arm of a microscope in the microscope system in FIG. 1 is rotated about a y axis.

FIG. 3 is a block diagram showing an image processing device provided in the microscope system in FIG. 1.

FIG. 4 is a diagram for explaining height measurement of an imaging object using the microscope system in FIG. 1.

FIG. 5 is a flowchart for explaining a measuring method using the microscope system in FIG. 1.

FIG. 6 is a diagram for explaining a state in which the microscope is set to a eucentric position in the measuring method in FIG. 5.

FIG. 7 is a diagram showing an example of a first image acquired by an imaging unit in the measuring method in FIG. 5.

FIG. 8 is a diagram showing an example of a second image acquired by the imaging unit in the measuring method in FIG. 5.

FIG. 9 is a diagram for explaining a modification of the height measurement in FIG. 4.

FIG. 10 is a schematic diagram for explaining three-dimensional point groups obtained by means of a modification of the measuring method using the microscope system in FIG. 1.

### DESCRIPTION OF EMBODIMENT

A microscope system (measuring apparatus) 1 and a measuring method according to an embodiment of the present invention will be described below with reference to the drawings.

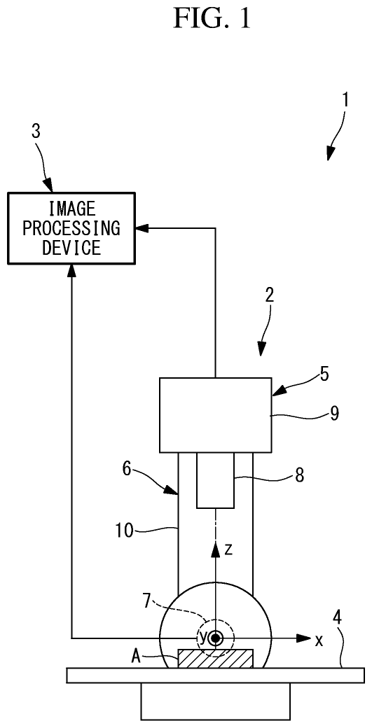

As shown in FIG. 1, the microscope system 1 according to this embodiment includes a microscope 2 and an image processing device 3.

As shown in FIG. 1, the microscope 2 includes: a stage 4 on which an imaging object A is mounted; an imaging unit 5 that is disposed above the stage 4 so as to face downward and that acquires an image of the imaging object A; a rotary moving portion 6 that relatively and rotationally moves the imaging unit 5 and the stage 4; and an angle detection unit 7 that detects a rotation angle formed by means of the rotary moving portion 6.

The imaging unit 5 includes: an objective optical system (optical system) 8 that is telecentric at least on the object side; and an image-capturing optical system 9 including an image-capturing element (not shown) that captures an image of light coming from the imaging object A and collected by the objective optical system 8.

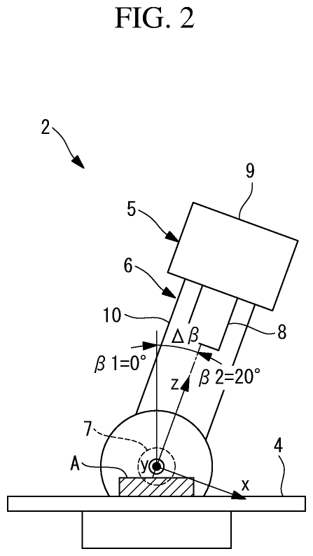

The rotary moving portion 6 includes an arm 10 on which the imaging unit 5 is mounted and, as shown in FIG. 2, rotationally moves the imaging unit 5 with respect to the stage 4 by rotating the arm 10 about an axis (y axis) orthogonal to an optical axis (z axis) of the objective optical system 8.

The angle detection unit 7 is, for example, an encoder.

The image processing device 3 is connected to the imaging unit 5 and the angle detection unit 7 and calculates a height dimension of the imaging object A on the basis of two images acquired by the imaging unit 5 before and after the rotational movement by means of the rotary moving portion 6 and the rotation angle detected by the angle detection unit 7.

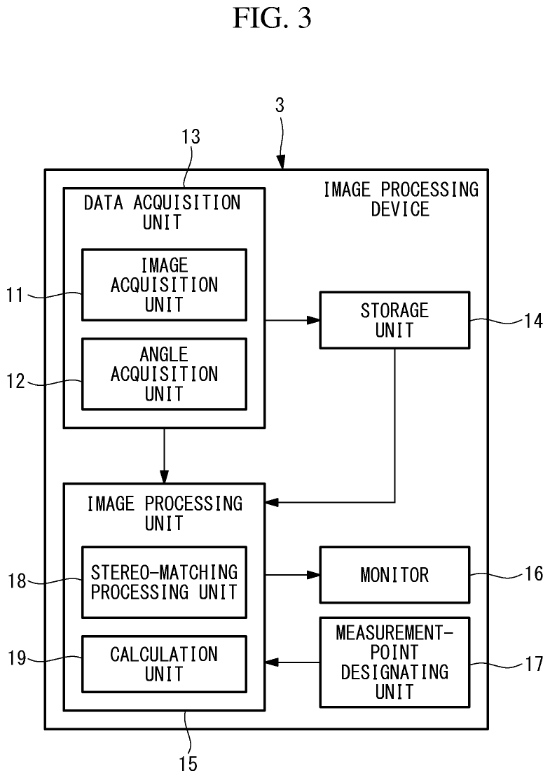

More specifically, as shown in FIG. 3, the image processing device 3 includes: a data acquisition unit 13 including an image acquisition unit 11 that acquires an image transmitted from the imaging unit 5 and an angle acquisition unit 12 that acquires a rotation angle transmitted from the angle detection unit 7; a storage unit 14 that stores the image and the rotation angle acquired by the data acquisition unit 13 in association with each other; an image processing unit 15 that performs image processing on the basis of the image and the rotation angle acquired by the data acquisition unit 13 and the image and the rotation angle acquired at the previous time and stored in the storage unit 14; a monitor (display unit) 16 that displays the image; and a measurement-point designating unit 17 that designates a measurement point on the monitor 16.

The storage unit 14 is a memory, the data acquisition unit 13 and the image processing unit 15 are processors, and the measurement-point designating unit 17 is an input device, such as a mouse or a keyboard, for moving a cursor on the monitor 16.

The image processing unit 15 includes: a stereo-matching processing unit 18 that identifies the coordinates of a measurement point on the other image, the measurement point corresponding to the measurement point designated on one image by the measurement-point designating unit 17, by utilizing an inter-image matching technique represented by template matching using information on peripheral pixels of a designated measurement point; and a calculation unit 19 that calculates the height of the imaging object A at the measurement point on the basis of the identified coordinates and the difference between the rotation angles.

In this embodiment, as shown in FIGS. 1 and 2, the two images are acquired before and after the arm 10 is rotated about the y axis, and thus, the y coordinates of the corresponding pixels are the same on both images. Therefore, it suffices that the stereo-matching processing unit 18 perform the matching processing only at the same y coordinates. In addition, in order to stabilize matching processing between images involving deformation, the matching processing may be performed by using a publicly known technology such as the Affine-SIFT algorithm.

The calculation unit 19 calculates the height of the imaging object A at a measurement point (point of interest) by using the arithmetic expression shown in Equation (1) below.

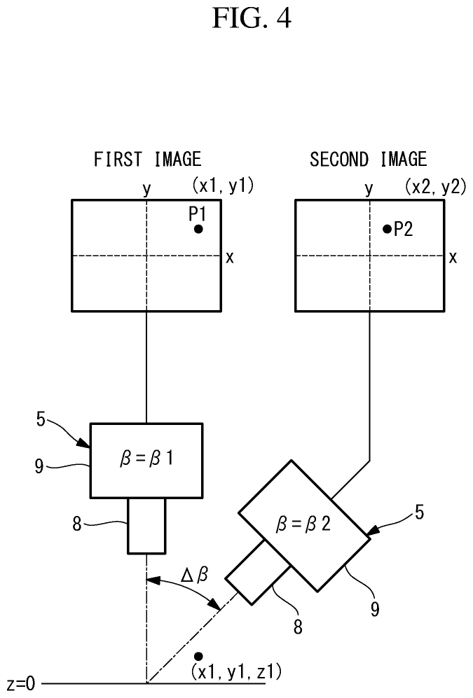

To simplify the explanation, as shown in FIG. 4, an angle (first rotation angle, rotation angle) of the arm 10 is assumed to be β=β1=0°, the coordinates of a measurement point P1 on a first image (first image) acquired by the imaging unit 5 in a state in which the optical axis of the objective optical system 8 is disposed in the vertical direction are assumed to be (x1, y1), an angle (second rotation angle, rotation angle) of the arm 10 is assumed to be β=β2, and the coordinates of a measurement point P2 on a second image (second image) acquired by the imaging unit 5 are assumed to be (x2, y2). In addition, a height dimension to be measured at the measurement point P1 is assumed to be z1. In this case, the angle difference Δβ is expressed by Δβ=β2−β1.

z1=(x1 cos Δβ−x2)/sin Δβ (1)

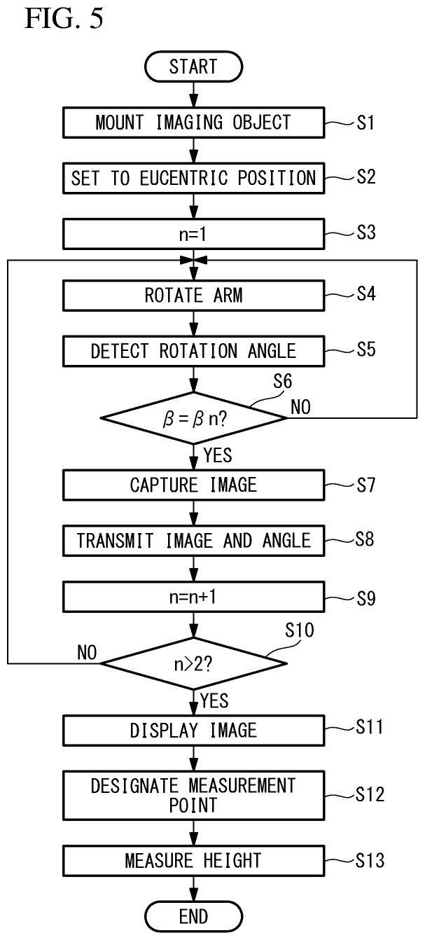

The measuring method using the thus-configured microscope system 1 according to this embodiment will now be described with reference to the flowchart in FIG. 5.

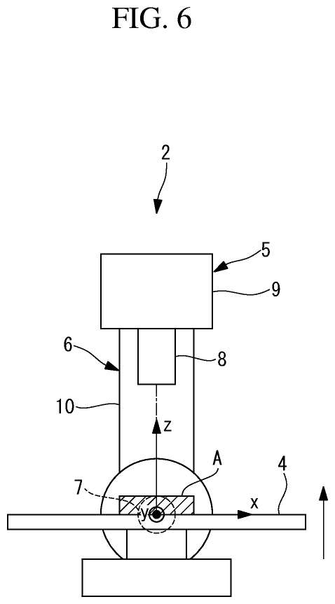

To measure the height of the imaging object A by using the microscope system 1 according to this embodiment, first, as shown in FIG. 1, the imaging object A is mounted on the stage 4 (step S1) and, as shown in FIG. 6, the position of the stage 4 in the height direction is set to a eucentric position (step S2).

Here, “eucentric” means a state in which the imaging object A is captured at the center of an image even when the imaging unit 5 including the telecentric objective optical system 8 is rotated with respect to the imaging object A, and means the case in which the focus is also maintained.

To achieve the eucentric position, the stage 4 is provided with a mechanism for adjusting the position of the stage 4 in the z direction in accordance with the height of the imaging object A. In addition, the position of the imaging unit 5 in the z direction is also adjusted so that the entire imaging object A is included within the focal depth of the objective optical system 8.

Next, a counter n is set to an initial value (step S3), and the rotary moving portion 6 is operated to rotate the arm 10 about the y axis (step S4). A rotation angle β is detected by an encoder serving as the angle detection unit 7 (step S5), and it is determined whether or not the detected rotation angle β is a prescribed angle βn (step S6).

When the prescribed angle βn is obtained, the imaging unit 5 is operated to acquire an image (step S7). The acquired image and the rotation angle βn are transmitted to the image processing device 3 (step S8). Then, the image acquisition unit 11 and the angle acquisition unit 12 in the image processing device 3 receive the image and the rotation angle βn, respectively, and the counter n is incremented (step S9). It is determined whether or not the counter n is greater than 2 (step S10), and if the counter n is equal to or less than 2, the steps from step S4 are repeated.

If the counter n is greater than 2, the image processing device 3 displays the transmitted first image on the monitor 16 (step S11), and an observer operates the measurement-point designating unit 17 to move a cursor on the first image displayed on the monitor 16 and designates a measurement point P1 at which a height dimension z1 needs to be measured (step S12). By doing so, the coordinates (x1, y1) of the measurement point P1 on the first image are set.

When the measurement point P1 is designated, the stereo-matching processing unit 18 searches for and identifies, in a second image, a measurement point P2 corresponding to the measurement point P1 designated on the first image by means of the stereo-matching processing. By doing so, the coordinates (x2, y2) of the measurement point P2 on the second image are set.

As a result of the set x coordinates x1, x2 of the two measurement points P1, P2 and the rotation angles β1, β2 being sent to the calculation unit 19, it is possible to precisely calculate the height dimension z1 at the measurement point P1 by using Equation (1) (step S13).

As described above, with the microscope system 1 and the measuring method according to this embodiment, there is an advantage in that parallax is generated by performing a tilting operation, in which the optical axis of the imaging unit 5 having the telecentric objective optical system 8 is arranged so as to have different inclination angles with respect to the imaging object A, whereby it is possible to precisely calculate the height dimension z1 at the measurement point P1, by means of stereo measurement, on the basis of the two acquired images and the difference Δβ between the rotation angles β1, β2.

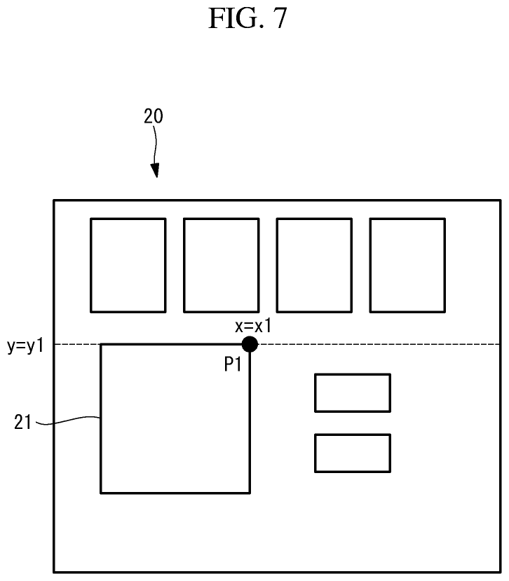

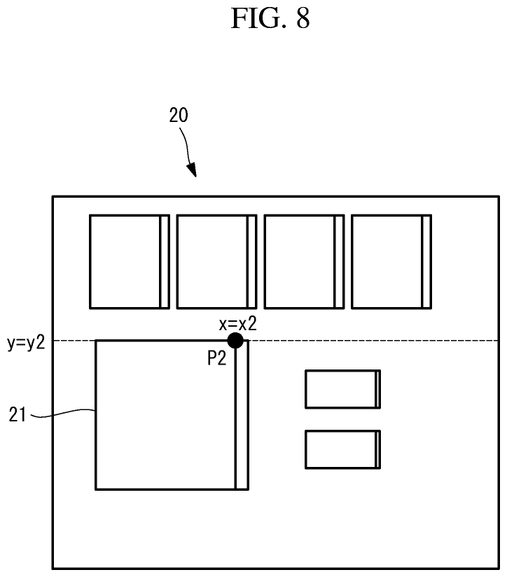

Note that, in this embodiment, it is preferable that the observer define a reference plane in addition to the measurement point. For example, in FIGS. 7 and 8, in the case in which a height dimension z1 of an electronic component (imaging object) 21 disposed on a substrate 20 is measured, at least three measurement points Q1, Q2, Q3 (not shown) may be designated on the surface of the substrate 20 to measure three-dimensional coordinate values and determine a plane on which the substrate 20 is present, a three-dimensional coordinate value of a measurement point P1 may be subsequently measured, and the height dimension z1 may be measured on the basis of the distance between the determined plane in the three-dimensional space and the measurement point P1.

In addition, because the telecentric objective optical system 8 forms a parallel projection image, if the pixel pitch of the image-capturing element of the image-capturing optical system 9 and the lens magnification are known, the xy coordinates on the image can be converted to the scale of the real space. By doing so, it is possible to obtain a three-dimensional coordinate value of a measurement point and a height dimension on the scale of the real space.

In addition, in this embodiment, the case in which the height dimension z1 is calculated by using a pair of images acquired at the rotation angles β1, β2 of the arm 10 has been illustrated as an example; however, the present invention is not limited thereto, and the height dimension z1 may be calculated by using two or more pairs of images.

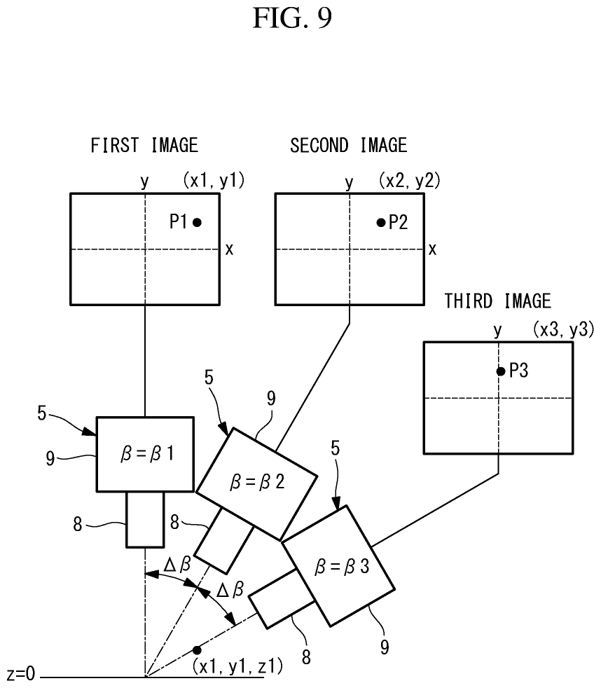

For example, as shown in FIG. 9, first to third images may be acquired at three positions with the rotation angles β1, β2, β3 of the arm 10; using two pairs of images, that is, a pair consisting of the first image and the second image and a pair consisting of the first image and the third image, the heights may be individually calculated by using Equation (1); and a height dimension z1 may be calculated by means of statistical processing, such as addition and averaging or a median value. In this example, the determination of the counter n (step S10) in FIG. 5 is indicated by “n>3?”.

More specifically, when β1=0°, β2=20°, and β3=40°, it is permissible to use a pair of images acquired at the rotation angles of 0° and 20° and a pair of images acquired at the rotation angles of 0° and 40°.

Changing the angle of the optical axis with respect to the imaging object A changes the texture of the image, thus causing an error in the stereo-matching processing; however, a robust height measurement can be performed by calculating a height dimension z1 by means of statistical processing of a plurality of heights. It is possible to enhance the robustness by increasing the number of data.

In addition, it is also possible to use a pair of images acquired at the rotation angles of 20° and 40°. In this case, a height in the z-coordinate direction is obtained assuming that the arm 10 is rotated about the y axis by an angle from β1=0° to β2=20°; thus, the obtained height may be multiplied by cos 20° to perform conversion to a height in the z-coordinate direction in the case of β1=0°.

In addition, a statistical value may be calculated by adding a weight based on the difference in the luminance value between the images, at the measurement points P1, P2 identified by means of the stereo-matching processing. Alternatively, as in publicly known multi-baseline stereo processing, one stable height dimension z1 may be calculated by integrating a plurality of stereo-matching evaluation values.

In addition, although the height is measured at the measurement point P1 designated by the measurement-point designating unit 17 in this embodiment, alternatively, the height may be measured at all pixels, serving as the measurement points P1, on the first image acquired at β1=0°. However, because the height measurement cannot be performed in a non-textured region in which the stereo-matching processing cannot be performed in principle, the contrast is checked in local regions in the first image, and the regions having a contrast equal to or less than a prescribed threshold are excluded from the measurement target.

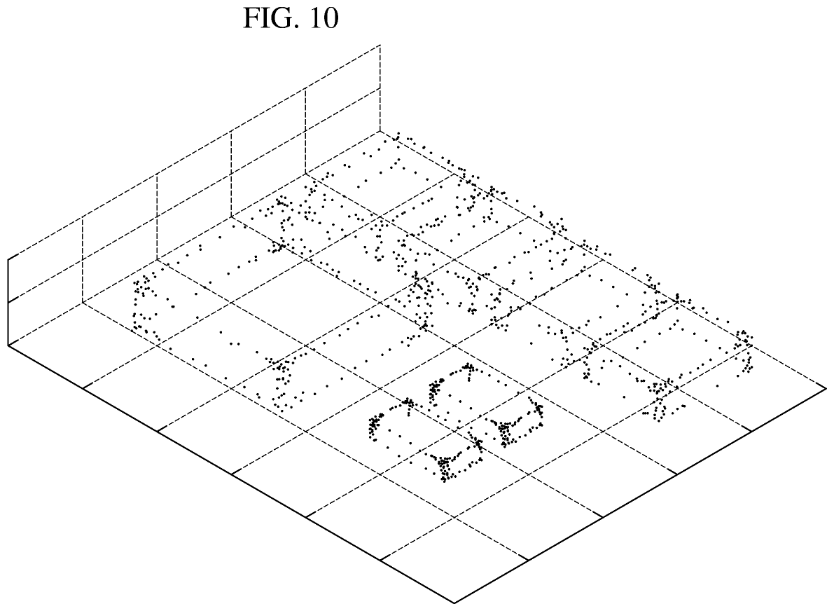

By doing so, as shown in FIG. 10, it is possible to generate three-dimensional point groups over the entire visual field of the imaging unit 5.

Here, there is a shielded region (occlusion) that cannot be observed in the first image. For example, a side surface of the imaging object A, which is parallel to the optical axis of the objective optical system 8, is not included in the first image. Accordingly, as shown in FIG. 8, three-dimensional point groups at the viewpoint of the second image are generated in a similar procedure from the second image and the third image acquired by changing the angle of the optical axis with respect to the imaging object A, and the generated three-dimensional point groups are integrated with the three-dimensional point groups at the viewpoint of the first image.

The publicly known ICP algorithm or the like is used for positional alignment among the three-dimensional point groups for the integration.

By doing so, the three-dimensional point groups missing at the viewpoint of the first image can also be obtained. In addition, as for the measurement points that are common among the plurality of three-dimensional point groups, it is possible to enhance the robustness by performing integration using a statistical value.

Similarly, by obtaining three-dimensional point groups also at other viewpoints, it is possible to generate three-dimensional point groups with few omissions over the entire imaging object A.

Because it is impossible to perform image-capturing at the viewpoints of all surroundings merely by tilting the arm 10 in one direction, the stage 4 on which the imaging object A is mounted may be provided with a mechanism for rotating the stage 4 about an axis extending in the vertical direction. The rotation angle of the stage 4 may also be detected separately by an encoder (not shown). In addition, by utilizing the rotation angle of the stage 4, the rotation angle β of the arm 10, and the z position adjusted with the eucentric setting for initial values or the like of the ICP algorithm, it is possible to perform highly precise positional alignment of the three-dimensional point groups.

Furthermore, the calculation unit 19 may perform interpolation by applying publicly known mesh processing or the like to the three-dimensional point groups including the non-textured regions or the like in which three-dimensional point groups could not be obtained the last time, thereby generating the final three-dimensional image. By generating the three-dimensional image, the observer can easily ascertain the appearance of the entire imaging object A and can perform shape measurement or the like at any cross section of the imaging object A.

In addition, in the abovementioned embodiment, the three-dimensional shape is measured after the images and the rotation angles β at all viewpoints are acquired; however, as in the publicly known SLAM technology, three-dimensional point groups may be constructed, integrated, and displayed on the monitor 16 each time an image and a rotation angle β are acquired. According to the operations performed by the observer, such as tilting the arm 10 and rotating the stage 4, the image and the rotation angle β may be acquired at the time when the rotation angle β detected by the encoder serving as the angle detection unit 7 coincides with a preset angle, and three-dimensional point groups may be calculated in real time and displayed on the monitor 16.

Alternatively, according to the operations performed by the observer, such as tilting the arm 10 and rotating the stage 4, the image and the rotation angle β may be acquired at prescribed time intervals to generate three-dimensional point groups. By doing so, the observer can easily ascertain viewpoint positions where acquisition of three-dimensional point groups is insufficient.

In addition, although the case in which the observer manually operates the arm 10 has been illustrated as an example in this embodiment, alternatively, it is permissible to employ an electric rotary moving portion 6 that drives the arm 10 and the stage 4 by means of a motor in accordance with the operation of an operating unit (not shown) performed by the observer.

The above-described embodiment also leads to the following aspects.

An aspect of the present invention is a measuring apparatus including: an imaging unit that includes an optical system that is telecentric at least on an object side, and that acquires an image of an imaging object; a rotary moving portion that relatively and rotationally moves the imaging unit and the imaging object about an axis intersecting an optical axis of the optical system; an angle detection unit that detects a rotation angle formed by means of the rotary moving portion; and a calculation unit that calculates a height dimension of the imaging object on the basis of two images acquired by the imaging unit before and after a rotational movement by means of the rotary moving portion and the rotation angle detected by the angle detection unit.

With this aspect, the imaging object and the imaging unit are disposed at prescribed relative positions, the imaging unit acquires an image of the imaging object, the rotary moving portion is subsequently operated to relatively and rotationally move the imaging object and the imaging unit about the axis intersecting the optical axis of the optical system, and the angle detection unit detects the rotation angle. Then, the imaging unit acquires an image of the imaging object at relative positions after the rotation. By doing so, the height dimension of the imaging object is calculated by the calculation unit on the basis of the two images acquired before and after the rotational movement and the rotation angle.

In other words, the imaging unit makes it possible to measure individual positions on the imaging object in two-dimensional directions orthogonal to the optical axis, and with the abovementioned method, it is also possible to calculate height dimensions at the individual positions on the imaging object; thus, it is possible to measure a height dimension with a wide visual field and high precision by using a telecentric optical system.

In the abovementioned aspect, the imaging object may be fixed on the optical axis; and the rotary moving portion may rotationally move the imaging unit about the axis.

With this configuration, the imaging object is fixed on the optical axis, and the rotary moving portion rotationally moves the imaging unit, whereby two images and a rotation angle can be acquired.

In addition, in the abovementioned aspect, the imaging unit may be fixed at such a position that the imaging object is disposed on the optical axis; and the rotary moving portion may rotationally move the imaging object about the axis.

With this configuration, the imaging object is disposed on the optical axis of the fixed imaging unit, and the rotary moving portion rotationally moves the imaging object, whereby two images and a rotation angle can be acquired.

In addition, in the abovementioned aspect, the calculation unit may identify, by means of matching processing, coordinates in two directions orthogonal to the optical axis, the coordinates corresponding to the same point of interest on the two images.

With this configuration, the calculation unit can identify the two-dimensional coordinates orthogonal to the optical axis, the coordinates corresponding to the common point of interest on the two images, by performing the matching processing. In addition, the height of the imaging object at the point of interest can be calculated on the basis of the two-dimensional coordinates, and as a result, the three-dimensional coordinates of the point of interest can be obtained.

In addition, in the abovementioned aspect, the calculation unit may individually calculate height dimensions for a plurality of pairs of the images acquired at rotation angles different from each other, and may calculate the height dimension of the imaging object using a statistical value of the plurality of calculated height dimensions.

With this configuration, it is possible to improve the measurement precision for the height dimension of the imaging object. In the case in which a point of interest is identified by means of the image matching processing, a change in the rotation angle changes the texture of the image, thus causing an error in the matching processing; however, a robust measurement can be performed by calculating a plurality of height dimensions and using a statistical value thereof as the height dimension of the imaging object.

In addition, in the abovementioned aspect, the calculation unit may calculate three-dimensional coordinate values of a plurality of identical points of interest on the two images.

With this configuration, it is possible to obtain a plurality of three-dimensional point groups and to measure a three-dimensional shape of the imaging object.

In addition, in the abovementioned aspect, the calculation unit may generate three-dimensional shape information by using the three-dimensional coordinate values.

With this configuration, the three-dimensional image information is generated by using the obtained three-dimensional coordinate values, thus making it possible to observe the imaging object from various directions and to measure the shape of any cross section of the imaging object.

In addition, in the abovementioned aspect, the calculation unit may individually calculate the three-dimensional coordinate values for a plurality of pairs of the images acquired at rotation angles different from each other, and may integrate the calculated three-dimensional coordinate values.

With this configuration, the detailed shape of the imaging object may not be acquired in some cases depending on the angle of the imaging unit with respect to the three-dimensional imaging object; however, by changing the rotation angle between the imaging unit and the imaging object by means of the rotary moving portion, it becomes possible to acquire the shape that could not be acquired. Therefore, by integrating the three-dimensional coordinate values calculated using the plurality of pairs of images, three-dimensional point groups with few omissions can be obtained.

In addition, in the abovementioned aspect, the calculation unit may perform, when integrating the calculated three-dimensional coordinate values, positional alignment among the three-dimensional coordinate values by using the rotation angles detected by the angle detection unit.

With this configuration, it is possible to perform highly precise positional alignment among the obtained three-dimensional point groups.

In addition, in the abovementioned aspect, a display unit that displays the plurality of identical points of interest for which the three-dimensional coordinate values are calculated may be provided, and the calculation unit may calculate the three-dimensional coordinate value each time the two images are acquired by the imaging unit.

With this configuration, when the three-dimensional coordinate values of the points of interest are calculated by the calculation unit, the obtained three-dimensional point groups are displayed in real time on the display unit. By doing so, an observer can quickly ascertain an optical axis direction that requires further image-capturing.

In addition, another aspect of the present invention is a measuring method including: arranging an imaging unit that includes an optical system that is telecentric at least on an object side and that acquires an image of an imaging object and the imaging object so as to form a first rotation angle about an axis intersecting an optical axis of the optical system to acquire a first image with the imaging unit; arranging the imaging unit and the imaging object so as to form a second rotation angle about the axis to acquire a second image with the imaging unit; and calculating a height dimension of the imaging object on the basis of the first image and the second image acquired by the imaging unit and a difference between the first rotation angle and the second rotation angle.

In addition, another aspect of the present invention is a microscope system including: a microscope that includes: a stage on which an imaging object is mounted; an imaging unit that includes an objective optical system that is telecentric at least on an object side and that acquires an image of the imaging object; a rotary moving portion that relatively and rotationally moves the imaging unit and the stage about an axis intersecting an optical axis of the objective optical system; and an angle detection unit that detects a rotation angle between the imaging unit and the stage, which is formed by means of the rotary moving portion; and an image processing device that calculates a height dimension of the imaging object on the basis of two images acquired by the imaging unit before and after a rotational movement by means of the rotary moving portion and the rotation angle detected by the angle detection unit.

### REFERENCE SIGNS LIST

1 microscope system (measuring apparatus)
2 microscope
3 image processing device
4 stage
5 imaging unit
6 rotary moving portion
7 angle detection unit
8 objective optical system (optical system)
16 monitor (display unit)
19 calculation unit
21 electronic component (imaging object)
A imaging object
P1, P2, P3 measurement point (point of interest)
z1 height dimension
β, β3 rotation angle
β1 first rotation angle (rotation angle)
β2 second rotation angle (rotation angle)
Δβ difference

1. A measuring apparatus comprising:
an imager that includes an optical system that is telecentric at least on an object side, and that acquires an image of an imaging object;
a rotor that relatively and rotationally moves the imager and the imaging object about an axis orthogonal to an optical axis of the optical system;
an encoder that detects a rotation angle formed by means of the rotor; and
a processor comprising hardware, the processor being configured to calculates, by a principle of triangulation, a height dimension of the imaging object on the basis of a result of matching processing of two images acquired by the imager before and after a rotational movement by means of the rotor and the rotation angle detected by the encoder.

2. The measuring apparatus according to claim 1, wherein:
the imaging object is fixed on the optical axis; and
the rotor rotationally moves the imager about the axis.

3. The measuring apparatus according to claim 1, wherein:
the imager is fixed at such a position that the imaging object is disposed on the optical axis; and
the rotor rotationally moves the imaging object about the axis.

4. The measuring apparatus according to claim 1, wherein the processor is configured to identify, by means of the matching processing, coordinates in two directions orthogonal to the optical axis, the coordinates corresponding to the same point of interest on the two images.

5. The measuring apparatus according to claim 1, wherein the processor is configured to individually calculate height dimensions for a plurality of pairs of the images acquired at rotation angles different from each other, and calculate the height dimension of the imaging object using a statistical value of the plurality of calculated height dimensions.

6. The measuring apparatus according to claim 1, wherein the processor is configured to calculate three-dimensional coordinate values of a plurality of identical points of interest on the two images.

7. The measuring apparatus according to claim 6, wherein the processor is configured to generate three-dimensional shape information by using the three-dimensional coordinate values.

8. The measuring apparatus according to claim 6, wherein the processor is configured to individually calculate the three-dimensional coordinate values for a plurality of pairs of the images acquired at rotation angles different from each other, and integrate the calculated three-dimensional coordinate values.

9. The measuring apparatus according to claim 8, wherein the processor is configured to perform, when integrating the calculated three-dimensional coordinate values, positional alignment among the three-dimensional coordinate values by using the rotation angles detected by the encoder.

10. The measuring apparatus according to claim 8, further comprising a monitor that displays the plurality of identical points of interest for which the three-dimensional coordinate values are calculated,
wherein the processor is configured to calculate the three-dimensional coordinate value each time the two images are acquired by the imager.

11. A measuring method comprising:
arranging an imaging unit that includes an optical system that is telecentric at least on an object side and that acquires an image of an imaging object and the imaging object so as to form a first rotation angle about an axis orthogonal to an optical axis of the optical system to acquire a first image with the imaging unit;
arranging the imaging unit and the imaging object so as to form a second rotation angle about the axis to acquire a second image with the imaging unit; and
calculating, by a principle of triangulation, a height dimension of the imaging object on the basis of a result of matching processing of the first image and the second image acquired by the imaging unit and a difference between the first rotation angle and the second rotation angle.

12. A microscope system comprising:
a microscope that includes:
a stage on which an imaging object is mounted;
an imager that includes an objective optical system that is telecentric at least on an object side and that acquires an image of the imaging object;
a rotor that relatively and rotationally moves the imager and the stage about an axis orthogonal to an optical axis of the objective optical system; and
an encoder that detects a rotation angle between the imager and the stage, which is formed by means of the rotor; and
a processor comprising hardware, the processor being configured to calculate, by a principle of triangulation, a height dimension of the imaging object on the basis of a result of matching processing of two images acquired by the imager before and after a rotational movement by means of the rotor and the rotation angle detected by the encoder.
